(19) United States
(12) Patent Application Publication
(10) Pub. No.: US 2022/0330492 A1
(43) Pub. Date: Oct. 20, 2022

(54) CARBON DIOXIDE AND EXHAUST GAS CAPTURE DEVICE

(71) Applicant: Chung-Hsien Chen, Auckland (NZ)

(72) Inventor: Chung-Hsien Chen, Auckland (NZ)

(21) Appl. No.: 17/230,606

(22) Filed: Apr. 14, 2021

(51) Int. Cl. A01G 9/18; A01G 7/02; C02F 1/28

(52) U.S. Cl. CPC A01G 9/18; A01G 7/02; C02F 1/283

(57) ABSTRACT

A carbon dioxide and exhaust gas capture device that is a device being unique in the world and being able to truly suppress carbon dioxide is provides and has a cold water tank set, a photosynthetic tank set, and a terrestrial plant tank set. The cold water tank set reduces temperature of exhaust gas and filters toxic gases and pollutant particles. The photosynthetic tank set and the terrestrial plant tank set further photosynthesize the exhaust gas with organisms that derive energy from photosynthesis and terrestrial plants to produce oxygen. Moreover, the carbon dioxide and exhaust gas capture device requires low cost, has high efficiency, produces zero pollution during the process, has a long service life, and has high added value.

### BACKGROUND OF THE INVENTION

### 1. Field of the Invention

The present invention relates to a carbon dioxide and exhaust gas capture device, especially to a carbon dioxide and exhaust gas capture device that deals with exhaust gas from factories or households, such that 100% of the exhaust gas that contains carbon dioxide and PM2.5 pollutant particles and is exhausted from various factories can be processed to meet requirements of normal and clean air quality.

### 2. Description of the Prior Art(s)

There are several conventional ways to reduce an amount of emitted carbon dioxide: 1. Introducing exhaust gas containing carbon dioxide and with a high temperature of more than 100° C. into a photosynthetic room planted with aquatic plants, so as to allow the aquatic plants to synthesize oxygen from the carbon dioxide and emit the oxygen to the atmosphere; 2. Injecting the exhaust gas into geological formations or the deep ocean directly; 3. Making usable products from the carbon dioxide in the exhaust gas directly.

However, the aforementioned conventional ways have disadvantages as follows. 1. Introducing the high temperature exhaust gas into the photosynthetic room planted with the aquatic plants would make the water boil, causing death of the aquatic plants and preventing photosynthesis. 2. Directly injecting the exhaust gas into the geological formations or the deep ocean would destroy the ecological environment and incur high cost. 3. making the usable products from the carbon dioxide consumes only a small amount of the carbon dioxide and requires high investment in equipment, and thus is not cost-effective and not easy to promote.

Therefore, the conventional ways and devices to deal with the carbon dioxide have the aforementioned problems and shortcomings, and are needed to be improved.

### SUMMARY OF THE INVENTION

The main objective of the present invention is to provide a carbon dioxide and exhaust gas capture device to remove carbon dioxide and PM2.5 pollutant particles in exhaust gas. The carbon dioxide and exhaust gas capture device has a cold water tank set, a photosynthetic tank set, and a terrestrial plant tank set.

The cold water tank set includes a main tank, an air intake assembly, a first water inlet, a first water outlet, a first exhaust pipe, and multiple temperature sensors. The main tank has a top and a bottom defined on opposite ends of the main tank, and contains cold water. The air intake assembly includes a first air intake pipe and a filter. The first air intake pipe is mounted through the main tank, is disposed at the bottom of the main tank, and has an inner end disposed in the cold water in the main tank and multiple first air holes separately formed through the inner end of the first air intake pipe. The filter is mounted to an outer end of the first air intake pipe. The first water inlet is formed through the main tank and is disposed at the top of the main tank. The first water outlet is formed through the main tank and is disposed at the bottom of the main tank. The first exhaust pipe is mounted to the main tank and is disposed at the top of the main tank. The temperature sensors are mounted in the main tank and are disposed at the top and the bottom of the main tank.

The photosynthetic tank set includes a work tank, a second air intake pipe, a second water inlet, a second water outlet, and a second exhaust pipe. The work tank has an upper end and a lower end defined on opposite ends of the work tank, contains water, and cultivates multiple organisms that derive energy from photosynthesis. The second air intake pipe is mounted through the work tank, is disposed at the lower end of the work tank, and has an inner end disposed in the work tank below the organisms, an outer end connected with the first exhaust pipe and multiple second air holes separately formed through the inner end of the second air intake pipe. The second water inlet is formed through the work tank and is disposed at the upper end of the work tank. The second water outlet is formed through the work tank and is disposed at the lower end of the work tank. The second exhaust pipe is mounted to the work tank and is disposed at the upper end of the work tank.

The terrestrial plant tank set includes a planting tank, an air inlet, and a third exhausting pipe. The planting tank accommodates and cultivates multiple terrestrial plants. The air inlet is formed through the planting tank and is connected by the second exhaust pipe. The third exhausting pipe is mounted to the planting tank and fluidly communicates with an interior of the planting tank.

The carbon dioxide and exhaust gas capture device of the present invention has the following advantages. With the cold water tank set, the photosynthetic tank set, and a terrestrial plant tank set to filter and photosynthesize the exhaust gas containing carbon dioxide, pollutant particles in the exhaust gas can be filtered and emissions of the carbon dioxide can be reduced through photosynthesis of the organisms (such as the aquatic plants and the algae). Compared to the conventional ways of dealing with the exhaust gas, cost of consumables in the filtering process and pollutants generated during the process can be reduced. Moreover, additional products produced by the algae can be converted to new alternative energy, which is environmentally friendly. The carbon dioxide and exhaust gas capture device of the present invention requires low cost (about one thousand to one million U.S. dollars), has high efficiency (more than one million tons of carbon dioxide can be processed globally each day), produces zero pollution during the process, has a long service life (more one hundred years), and has high added value. According to a project called Bio Solar Cells, by using cyanobacteria to produce biofuel, which can be a substitute for petroleum, value of the additional products generated each year exceeds 1,000 times the cost of the whole equipment of the carbon dioxide and exhaust gas capture device of the present invention.

Other objectives, advantages and novel features of the invention will become more apparent from the following detailed description when taken in conjunction with the accompanying drawings.

### BRIEF DESCRIPTION OF THE DRAWINGS

FIG. 1 is a schematic diagram of a first embodiment of a carbon dioxide and exhaust gas capture device in accordance with the present invention;

FIG. 2 is a schematic diagram of a second embodiment of a carbon dioxide and exhaust gas capture device in accordance with the present invention; and

FIG. 3 is an operational schematic diagram of the carbon dioxide and exhaust gas capture device in FIG. 1, showing using with a water collection device.

### DETAILED DESCRIPTION OF THE PREFERRED EMBODIMENTS

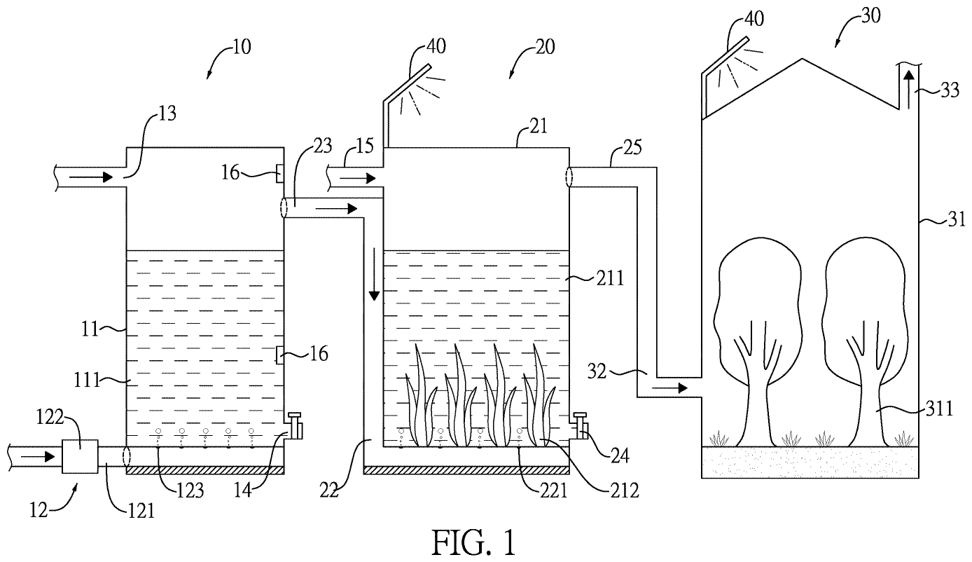

With reference to FIG. 1, a first preferred embodiment of a carbon dioxide and exhaust gas capture device in accordance with the present invention comprises a cold water tank set 10, a photosynthetic tank set 20, a terrestrial plant tank set 30, and multiple lighting devices 40.

As shown in FIG. 1, the cold water tank set 10 includes a main tank 11, an air intake assembly 12, a first water inlet 13, a first water outlet 14, a first exhaust pipe 15, and multiple temperature sensors 16.

The main tank 11 has a top and a bottom defined on opposite ends of the main tank 11. The main tank 11 contains cold water 111. Preferably, temperature of the cold water 111 is, but is not limited to, less than 40° C.

The air intake assembly 12 includes a first air intake pipe 121 and a filter 122. The first air intake pipe 121 is mounted through the main tank 11 and is disposed at the bottom of the main tank 11. The first air intake pipe 121 has an inner end, an outer end, and multiple first air holes 123. The inner end of the first air intake pipe 121 is disposed in the cold water 111 in the main tank 11. The first air holes 123 are separately formed through the inner end of the first air intake pipe 121 and are for exhausting. Preferably, the first air holes 123 are, but are not limited to be, separately arranged along an elongation axis of the first air intake pipe 121. The filter 122 is mounted to the outer end of the first air intake pipe 121 and may be an activated carbon filter assembly that can filter toxic gases.

The first water inlet 13 is formed through the main tank 11 and is disposed at the top of the main tank 11. The first water outlet 14 is formed through the main tank 11 and is disposed at the bottom of the main tank 11. A pipe is connected to the first water outlet 14 and is provided with a valve that is used for opening or closing the first water outlet 14. The first exhaust pipe 15 is mounted to the main tank 11, is disposed at the top of the main tank 11, and fluidly communicates with an interior of the main tank 11. The temperature sensors 16 are mounted on an inner sidewall of the main tank 11, are disposed at the top and the bottom of the main tank 11, and are used for detecting the temperature of the cold water 111 and air temperature inside the main tank 11.

The photosynthetic tank set 20 includes a work tank 21, a second air intake pipe 22, a second water inlet 23, a second water outlet 24, and a second exhaust pipe 25.

The work tank 21 has an upper end and a lower end defined on opposite ends of the work tank 21. The work tank 21 contains aquaculture water 211 and cultivates multiple organisms 212. The aquatic organisms may be aquatic plants, algae (such as cyanobacteria), or other organisms that derive energy from photosynthesis. Moreover, different aquatic organisms (preferably aquatic plants and algae) can be mixed and cultivated in the work tank 21 according to user's needs, and an appropriate amount of organism applicable soil may be added in the work tank 21. The work tank 21 is, but is not limited to be, made of transparent material.

The second air intake pipe 22 is mounted through the work tank 21 and is disposed at the lower end of the work tank 21. A position of the second air intake pipe 22 on the work tank 21 can be adjusted according to the user's needs. The second air intake pipe 22 has an inner end, an outer end, and multiple second air holes 221. The inner end of the second air intake pipe 22 is disposed in the work tank 21 and is, but is not limited to be, disposed below the organisms 212. The outer end of the second air intake pipe 22 is connected with the first exhaust pipe 15. The second air holes 221 are separately formed through the inner end of the second air intake pipe 22 and are for exhausting. Preferably, the second air holes 221 are, but are not limited to be, separately arranged along an elongation axis of the second air intake pipe 22.

The second water inlet 23 is formed through the work tank 21 and is disposed at the upper end of the work tank 21. The second water outlet 24 is formed through the work tank 21 and is disposed at the lower end of the work tank 21. A pipe is connected to the second water outlet 24 and is provided with a valve that is used for opening or closing the second water outlet 24. The second exhaust pipe 25 is mounted to the work tank 21, is disposed at the upper end of the work tank 21, and fluidly communicates with an interior of the work tank 21.

The terrestrial plant tank set 30 includes a planting tank 31, an air inlet 32, and a third exhausting pipe 33. The planting tank 31 accommodates and cultivates multiple terrestrial plants 311. The air inlet 32 is formed through the planting tank 31 and is connected by the second exhaust pipe 25. The third exhausting pipe 33 is mounted to the planting tank 31 and fluidly communicates an interior of the planting tank 31 to an exterior of the planting tank 31. In the preferred first embodiment, the planting tank 31 is, but is not limited to be, made of transparent material.

The lighting devices 40 are mounted on the work tank 21 of the photosynthetic tank set 20 and the planting tank 31 of the terrestrial plant tank set 30. In the first preferred embodiment, the lighting devices 40 are, but are not limited to, solar lamps that is able to illuminate the organisms 212 or the terrestrial plants 311.

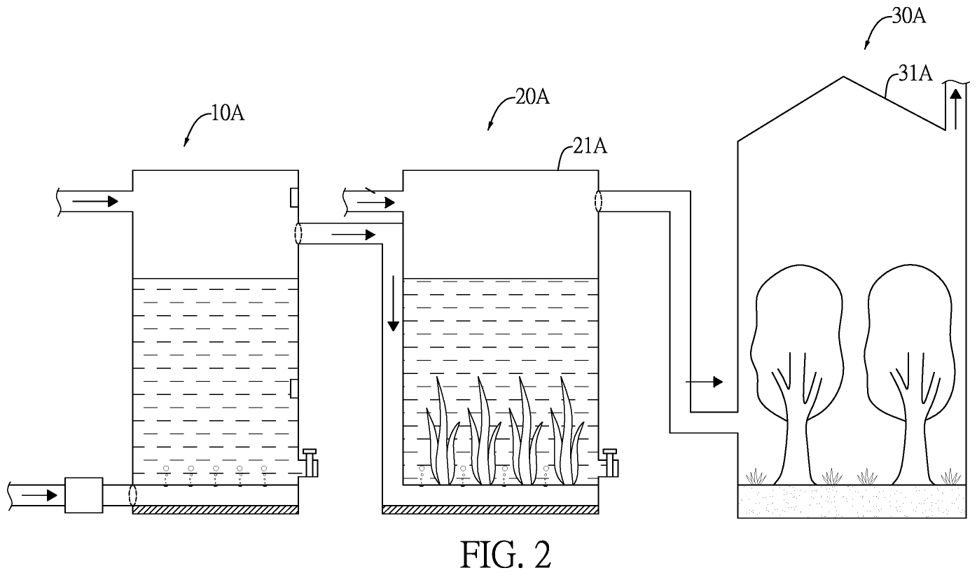

With further reference to FIG. 2, in a second preferred embodiment, the carbon dioxide and exhaust gas capture device comprises the cold water tank set 10A, the photosynthetic tank set 20A and the terrestrial plant tank set 30A as described in the first preferred embodiment. The lighting devices 40 are omitted, the work tank 21A and the planting tank 31A are made of transparent material instead, such that the photosynthetic tank set 20A and the terrestrial plant tank set 30A can be illuminated with the sunlight.

As shown in FIG. 1, during operation, exhaust gas from factories or households is delivered to the first air intake pipe 121, is filtered by activated carbon filter layer in the filter 122 to filter the toxic gases, and enters the cold water 111 of the main tank 11 through the first air holes 123 of the first air intake pipe 121. The cold water 111 in the main tank 11 cools the high temperature exhaust gas to room temperature, generally 10° C. to 40° C. During the cooling process, the temperature sensors 16 detect the temperatures of the cold water 111 and the filtered exhausted gas. When one of the temperatures of the cold water 111 and the filtered exhausted gas is higher than 40° C., additional cold water 111 is added into the main tank 11 through the first water inlet 13. An amount of the additionally added cold water 111 can be adjusted according to weather conditions.

The cold water 111 in the main tank 11 may be derived from external water source or internal water source. The external water source may be any suitable water source such as rain water or river water. When the rain water or the river water is insufficient, tap water may be used. The internal water source is derived by filtering and recycling the cold water 111 drained from the first water outlet 14 and adding the cold water 111 to the main tank 11 again through the first water inlet 13.

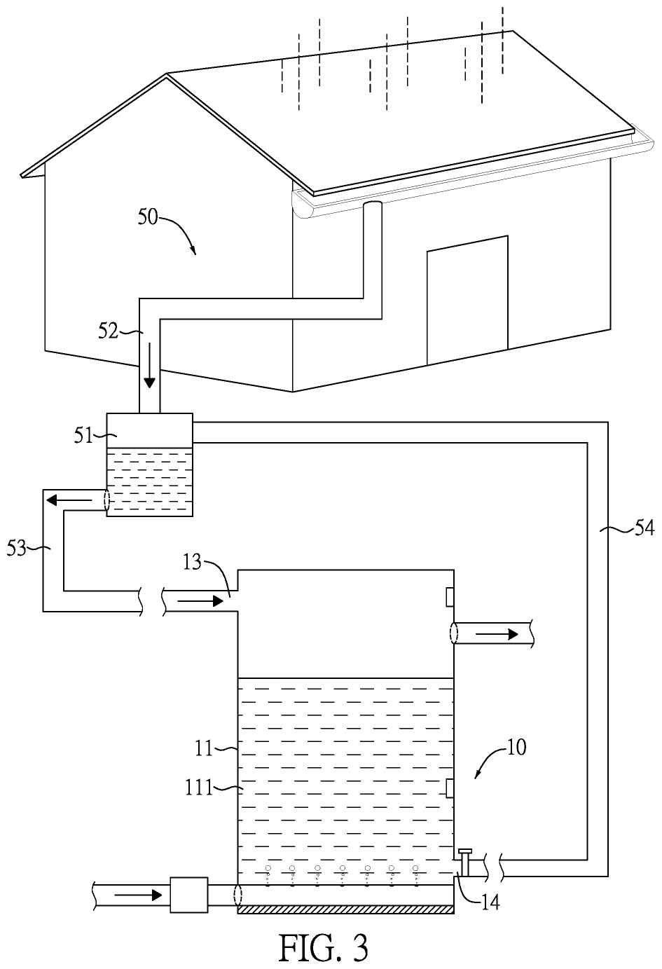

Specifically, with reference to FIG. 3, take using the cold water tank set 10 together with a water collection device 50 as an illustration. However, the cold water tank set 10 is not limited to be used together with the water collection device 50. The water collection device 50 includes a collection bucket 51, an introduction pipe 52, and a delivery pipe 53. The introduction pipe 52 has two ends connected to a rain gutter and the collection bucket 51 respectively, such that the rain water can be guided to flow into the collection bucket 51. The delivery pipe 53 has two ends connected to the collection bucket 51 and the first water inlet 13 of the main tank 11 respectively.

The first water outlet 14 of the main tank 11 may be connected to the collection bucket 51 through a recycling pipe 54, so as to pump the water in the main tank 11 to the collection bucket 51 for cooling. Thus, the water in the collection bucket 51 and in the main tank 11 can be recycled, which is environmentally friendly and water-saving, and the cold water 111 in the main tank 11 is able to preliminarily filter or dissolve PM2.5 pollutant particles in the exhaust gas.

The exhaust gas exhausted from the first exhausting pipe 15 enters the work tank 21 of the photosynthetic tank set 20 through the second air holes 221 of the second air intake pipe 22. Since the exhaust gas still contains some carbon dioxide, the carbon dioxide can be photosynthesized with the organisms 212 to produce the oxygen. Source of the aquaculture water 211 in the work tank 21 may be the same as the cold water 111 in the main tank 11 and thus will not be repeated. Gas containing the oxygen and the residual carbon dioxide flows into the planting tank 31 of the terrestrial plant tank set 30, so as to allow the residual carbon dioxide to be photosynthesized with the terrestrial plants 311 to produce the oxygen. Then the oxygen is discharged to the atmosphere. Accordingly, the carbon dioxide in the exhaust gas in reduced and the air can be purified.

In the aforementioned process, the exhaust gas that contains the carbon dioxide and the PM2.5 pollutant particles and is exhausted from various factories can be processed to meet requirements of normal and clean air quality. Said various factories may be small factories such as burning wood at home, or large factories such as fossil fuel power stations and oil refineries. The carbon dioxide and exhaust gas capture device of the present invention is especially suitable for dealing with the exhaust gas containing the carbon dioxide and the PM2.5 pollutant particles and exhausted from the large factories such as the fossil fuel power stations and the oil refineries. More than one million tons of carbon dioxide can be processed globally each day non-stop. Accordingly, the carbon dioxide and exhaust gas capture device of the present invention is of very high efficiency.

In the aforementioned process of processing the exhaust gas, since the plants are used as a medium for photosynthesis, pollution generated during the process can be reduced and is environmentally friendly. Related equipment of the carbon dioxide and exhaust gas capture device has a long service life, which can be more one hundred years.

In the aforementioned process, since the lighting devices 40 are provided, sufficient light can be provided at night or in low-light environments to promote photosynthesis of the aquatic plants, the algae and other organisms. Accordingly, the effect of filtering the carbon dioxide can be promoted.

In the aforementioned process, additional products produced by the organisms 212 can be converted into new alternative energy. For instance, the cyanobacteria can be converted to biofuel, which can be a substitute for petroleum and is environmentally friendly. Moreover, the maintenance cost of the carbon dioxide and exhaust gas capture device of the present invention is relatively low (about one thousand to one million U.S. dollars).

In the aforementioned process, since the temperature of the exhaust gas has been pre-cooled by the cold water 111 in the main tank 11 before entering the photosynthetic tank set 20, the temperature of the exhaust gas in the photosynthetic tank set 20 and for photosynthesis is suitable for growth of the organisms 212 such as the aquatic plants and the algae. Accordingly, the effect and the service life of the carbon dioxide and exhaust gas capture device of the present invention can be enhanced.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A carbon dioxide and exhaust gas capture device comprising:
a cold water tank set including:
a main tank having a top and a bottom defined on opposite ends of the main tank, and the main tank containing cold water;
an air intake assembly including:
a first air intake pipe mounted through the main tank, disposed at the bottom of the main tank, and having:
an inner end disposed in the cold water in the main tank;
an outer end; and
multiple first air holes separately formed through the inner end of the first air intake pipe; and
a filter mounted to the outer end of the first air intake pipe;
a first water inlet formed through the main tank and disposed at the top of the main tank;
a first water outlet formed through the main tank and disposed at the bottom of the main tank;
a first exhaust pipe mounted to the main tank and disposed at the top of the main tank; and
multiple temperature sensors mounted in the main tank and disposed at the top and the bottom of the main tank;
a photosynthetic tank set including:
a work tank having an upper end and a lower end defined on opposite ends of the work tank, and the work tank containing water and cultivating multiple organisms that derive energy from photosynthesis;
a second air intake pipe mounted through the work tank, disposed at the lower end of the work tank, and having
an inner end disposed in the work tank below the organisms;
an outer end connected with the first exhaust pipe; and
multiple second air holes separately formed through the inner end of the second air intake pipe;
a second water inlet formed through the work tank and disposed at the upper end of the work tank;
a second water outlet formed through the work tank and disposed at the lower end of the work tank; and
a second exhaust pipe mounted to the work tank and disposed at the upper end of the work tank; and
a terrestrial plant tank set including
a planting tank accommodating and cultivating multiple terrestrial plants;
an air inlet formed through the planting tank and connected by the second exhaust pipe; and
a third exhausting pipe mounted to the planting tank and fluidly communicating with an interior of the planting tank.

2. The carbon dioxide and exhaust gas capture device as claimed in claim 1 further comprising multiple lighting devices, and the lighting devices mounted on the work tank of the photosynthetic tank set and the planting tank of the terrestrial plant tank set.

3. The carbon dioxide and exhaust gas capture device as claimed in claim 1, wherein the filter is an activated carbon filter layer.

4. The carbon dioxide and exhaust gas capture device as claimed in claim 2, wherein the filter is an activated carbon filter layer.

5. The carbon dioxide and exhaust gas capture device as claimed in claim 3, wherein the organisms are algae.

6. The carbon dioxide and exhaust gas capture device as claimed in claim 4, wherein the organisms are algae.

7. The carbon dioxide and exhaust gas capture device as claimed in claim 3, wherein the organisms are aquatic plants.

8. The carbon dioxide and exhaust gas capture device as claimed in claim 4, wherein the organisms are aquatic plants.

9. The carbon dioxide and exhaust gas capture device as claimed in claim 3, wherein the organisms are algae and aquatic plants.

10. The carbon dioxide and exhaust gas capture device as claimed in claim 4, wherein the organisms are algae and aquatic plants.

11. The carbon dioxide and exhaust gas capture device as claimed in claim 5, wherein the work tank of the photosynthetic tank set and the planting tank of the terrestrial plant tank are made of transparent material.

12. The carbon dioxide and exhaust gas capture device as claimed in claim 6, wherein the work tank of the photosynthetic tank set and the planting tank of the terrestrial plant tank are made of transparent material.

13. The carbon dioxide and exhaust gas capture device as claimed in claim 7, wherein the work tank of the photosynthetic tank set and the planting tank of the terrestrial plant tank are made of transparent material.

14. The carbon dioxide and exhaust gas capture device as claimed in claim 8, wherein the work tank of the photosynthetic tank set and the planting tank of the terrestrial plant tank are made of transparent material.

15. The carbon dioxide and exhaust gas capture device as claimed in claim 9, wherein the work tank of the photosynthetic tank set and the planting tank of the terrestrial plant tank are made of transparent material.

16. The carbon dioxide and exhaust gas capture device as claimed in claim 10, wherein the work tank of the photosynthetic tank set and the planting tank of the terrestrial plant tank are made of transparent material.

17. The carbon dioxide and exhaust gas capture device as claimed in claim 5 further comprising a water collection device and the water collection device including:
a collection bucket;
a delivery pipe has two ends connected to the collection bucket and the first water inlet of the main tank respectively; and
a recycling pipe has two ends connected to the first water outlet of the main tank and the collection bucket respectively.

18. The carbon dioxide and exhaust gas capture device as claimed in claim 6 further comprising a water collection device and the water collection device including:
a collection bucket;
a delivery pipe has two ends connected to the collection bucket and the first water inlet of the main tank respectively; and
a recycling pipe has two ends connected to the first water outlet of the main tank and the collection bucket respectively.

19. The carbon dioxide and exhaust gas capture device as claimed in claim 7 further comprising a water collection device and the water collection device including:
a collection bucket;
a delivery pipe has two ends connected to the collection bucket and the first water inlet of the main tank respectively; and
a recycling pipe has two ends connected to the first water outlet of the main tank and the collection bucket respectively.

20. The carbon dioxide and exhaust gas capture device as claimed in claim 8 further comprising a water collection device and the water collection device including:
a collection bucket;
a delivery pipe has two ends connected to the collection bucket and the first water inlet of the main tank respectively; and
a recycling pipe has two ends connected to the first water outlet of the main tank and the collection bucket respectively.
